(19) United States
(12) Patent Application Publication
(10) Pub. No.: US 2011/0119105 A1
(43) Pub. Date: May 19, 2011

(54) SYSTEM AND METHOD FOR CONDUCTING NON-NOUISANT SURVEYS OVER VIRTUAL NETWORKS

(76) Inventors: Genady Grabarnik, (US); Dimitri Kanevsky, (US); Mark E. Podlaseck, (US); Larisa Shwartz, (US)

(21) Appl. No.: 12/621,488

(22) Filed: Nov. 18, 2009

(51) Int. Cl. G06Q 10/00; G06F 3/048; G06F 17/30; G06Q 50/00

(52) U.S. Cl. 705/7.28; 715/706; 707/769; 705/347; 707/E17.108

(57) ABSTRACT

A polling method, online polling system and program product therefor. A system avatar unit creates, maintains and controls system avatars distributed throughout a virtual world. System avatars receive questions received from polling system clients. A dialogue module manages dialogs between system avatars presenting the questions to user avatars in the virtual world. A report generator generates reports responsive to responses given by user avatars to system avatars.

### FIELD OF THE INVENTION

The present invention generally relates to systems and methods of conducting surveys and polling users.

### BACKGROUND DESCRIPTION

Currently, polling companies and organizations use pop-ups, spam e-mail, and online surveys to conduct polls and surveys over the Internet. Because a pop-up can direct one to a potentially hazardous web site and because pop-ups have become so prevalent as to interfere with normal browsing, state of the art browsers usually include a pop-up blocker capability. A pop-up blocker can prevent survey questions from ever reaching potential poll participants, even participants that might otherwise want to participate in a particular poll. Several Internet security application providers have developed spam filters that intercept suspected spam, often before it enters one's inbox. Bypassing these safeguards to participate in a particular poll often requires a user to take extra steps to defeat/bypass the safeguards, and take extra time to complete a survey.

Consequently, polling companies and organizations that conduct on-line, interactive polls and surveys, e.g., over the Internet, frequently are required to offer incentives to entice users through these counter-measures to encourage users to complete surveys. These incentives add extra costs to the surveying process. Even with appropriate incentives conducting on-line polls through virtual networks present potential poll takers with a nuisance the potential poll taking Internet users would likely rather avoid.

Thus, there is a need for conducting online surveys and polling users that does not detract from the user's online experience, such that polling companies and organizations may save money and avoid offering incentives to willing users completing the surveys.

### SUMMARY OF THE INVENTION

It is a purpose of the invention to facilitate online polling and surveys;

It is another purpose of the invention to conduct online polling and surveys without detracting from online experience of users taking the poll/survey;

It is yet another purpose of the invention to encourage willing participation in online polls and surveys.

The present invention relates to a polling method, online polling system and program product therefor. A system avatar unit creates, maintains and controls system avatars distributed throughout a virtual world. System avatars receive questions received from polling system clients. A dialogue module manages dialogs between system avatars presenting the questions to user avatars in the virtual world. A report generator generates reports responsive to responses given by user avatars to system avatars.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 shows an example of a system 100 for conducting on-line surveys and polling users according to a preferred embodiment of the present invention;

FIG. 2 shows an example of creating surveys and polling users, even distant users, through virtual networks without interfering with or, detracting from, each individual user's online experience;

FIG. 3 shows an example of generating surveys/questionnaires and presenting those surveys/questionnaires to users through UCAs.

### DESCRIPTION OF PREFERRED EMBODIMENTS

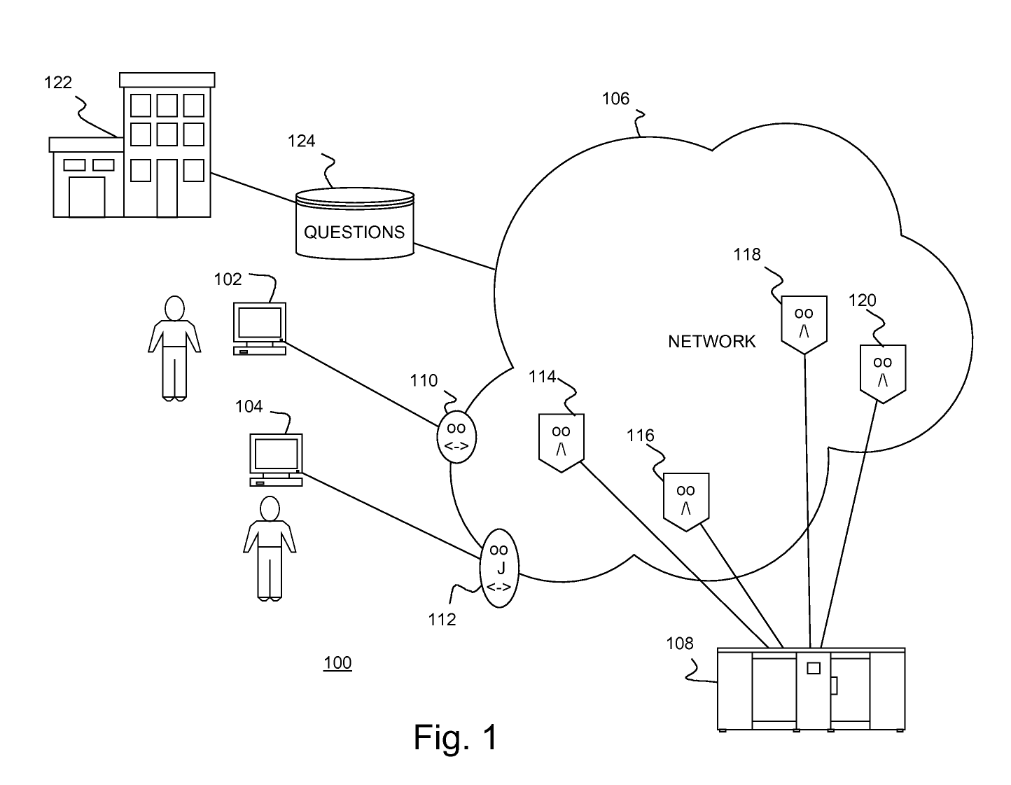

Turning now to the drawings and, more particularly, FIG. 1 shows an example of a system 100 for conducting online surveys and polling users according to a preferred embodiment of the present invention. User devices 102, 104 are connected, e.g., over a network/virtual world 106, to a preferred Virtual Avatar Polling System (VAPS) 108, e.g., in a remote server. Each user creates, owns and maintains a system presence, e.g., avatars 110, 112, in the virtual world 106. User avatars 110, 112 also are referred to herein as User Controlled Avatars (UCAs). The VAPS 108 creates, maintains and controls several system avatars, 114, 116, 118, 120, in the virtual world 106. These system avatars, 114, 116, 118, 120 also are referred to herein as VAPS Controlled Avatars (VCAs). A business/client 122 provides questions, e.g., in the form of a questionnaire 124, to VAPS 108 for presenting to users, e.g., in online surveys and polling users. Typically, the system includes multiple businesses/clients 122, each providing one or more questionnaires 124. The VCAs 114, 116, 118, 120 present the questions to UCAs 110, 112 as they encounter each other in the virtual world 106. Thus, a preferred VAPS 108 performs randomized polling in conversational based virtual interaction.

Each user has an avatar (UCA 108, 110), a virtual character, that they can navigate through the virtual world. Avatars are commonly used in video gaming, e.g. the Wii™ from Nintendo® and the XBOX Live from Microsoft® Corporation. In interactive video gaming on-line users compete over a network such as the Internet. In Second Life®, for example, each user controls an avatar that may interact freely with other avatars in a virtual world. As each user joins the system, the user creates his/her own UCA 108, 110 as a virtual presence within the system. The VAPS 108 allows client organizations 122 to poll users using suitable artificial intelligence communication technology (e.g., neural nets or statistical models that based on Hidden Markov models or Bayesian networks), virtually embodied as system avatars. Thus, the VAPS 108 maintains virtual presences on the system through VCAs 114, 116, 118, 120, that interact with the UCAs 110, 112. The VCAs 114, 116, 118, 120 are randomly distributed throughout the virtual world 106 and interact with UCAs 110, 112 at a predetermined rate. Thus, the randomly distributed VCAs 114, 116, 118, 120 perform random single polling events throughout each user's session unobtrusively polling the users during the session.

A client company 122 creates a series of questions 124 as, for example, a questionnaire 124 that the client company 122 wishes answered by the public. The client company 122 submits the questions 124 over the network 106 to VAPS 108. The VAPS 108 designates a VCA, e.g., 116, or multiple VCAs to interact with UCAs 110, 112, collecting answers to the questions 124. The VCAs 114, 116, 118, 120 may be programmed to question the UCAs 110, 112, e.g., marketing, business, scientific, and public safety questions 124. Thus, the VAPS 108 systematically poses the questions 124 using the various VCAs 114, 116, 118, 120 that interact with UCAs 110, 112, seamlessly and hidden to the user without the user being aware in some cases that he/she is being question. The VAPS 108 also can create dynamic surveys where in one virtual world session, UCAs 110, 112 can interact with many different VCAs 114, 116, 118, 120 answering multiple questions that are related to the same poll or survey.

Questions may be formulated to appear as part of a general conversation or related to some aspect of the virtual world, while masking the true intent of the question and data being collected. For example, VAPS 108 may be collecting information regarding which one of two candidates X and Y UCA users would vote. The VCAs 114, 116, 118, 120 do not ask directly each UCA's preference. Instead, one VCA 114, 116, 118, 120 tells a story. The story may indicate that the watched TV debates between X and Y. Then, after the story, the CA may follow with something like “I liked as X performed more than Y,” and ask the UCA how it liked how candidate X performed. The UCA may respond saying, “I think Y made better points” and/or “Y was more presidential.” The VCA follows up with “do you think you would vote X because he performed better on TV?” By asking these indirect questions, masks the questioning which appears as part of common conversation rather then polling.

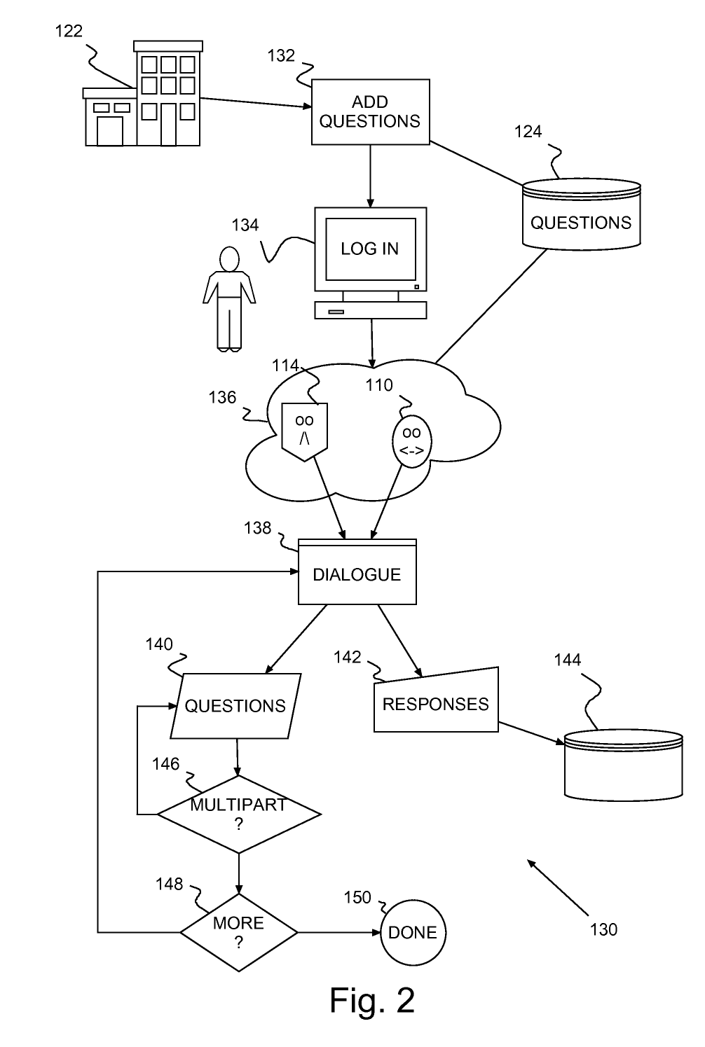

FIG. 2 shows an example 130 of creating surveys and polling users, even distant users, through virtual networks without interfering with or, detracting from, each individual user's online experience with reference to the preferred system of FIG. 1. This example begins in 132 when a client company 122 independently creates questions 124 for a survey to be implemented by VAPS 108 through VCAs 114, 116, 118, 120. At some point in 134 a user logs into their avatar or creates a new avatar, e.g., UCA 110, and navigates a virtual world. It should be noted that questions may be created/provided 132 before, after, or simultaneously with, a user logging in 134. A preferred system 100 may be used, for example, for questioning patient users, and especially, questioning elderly patients on different subjects. Questioning may be conducted over a virtual network(s), using the patient's answers to make initial estimates of the patient's mood or state of mind.

When a user logs in 134, one of the VCAs, e.g., 116, approaches 136 that user's UCA, e.g., 110. In the virtual world, the VCAs 114, 116, 118, 120 appear no different than the UCAs 110, 112. The avatars, 110 and 116 in this example, converse normally, carrying on a dialogue 138 that is no different than a dialogue between two UCAs 110, 112. During the dialogue 138, the VCA 116 poses a question or questions 140 to UCA 110. Optionally, pollster users can enter the virtual world logging in 134, e.g., as UCA 112. Once logged in the, UCA 112 can scan user profiles, e.g., stored in storage 124, for the UCAs of people that match criteria of interest. Once a matching UCA is found, e.g., 110, the pollster UCA 112 teleports itself to online matching UCA 110 and unobtrusively questions the UCA 110.

In another example, a VCA 116 may ask “Who do you think should be president, Hillary Clinton or Barack Obama?” The UCA 110 responds 142 to the polling question The VCA 116 logs the response 142, and stores 144 logged responses. Responses may be stored 144 locally in the VAPS 108 or remotely, e.g., in the storage 122 with the questions. For multipart questions or questions that depend on a previous response, the response to the current question (e.g., “Did you vote in the last election?”) can terminate the line of questioning or lead to a number of other subsequent follow up questions. In 146 the VAPS 108 decides whether to direct the VCA 110 to the next follow up question. Once the dialogue is complete 148, the conversation terminates 150.

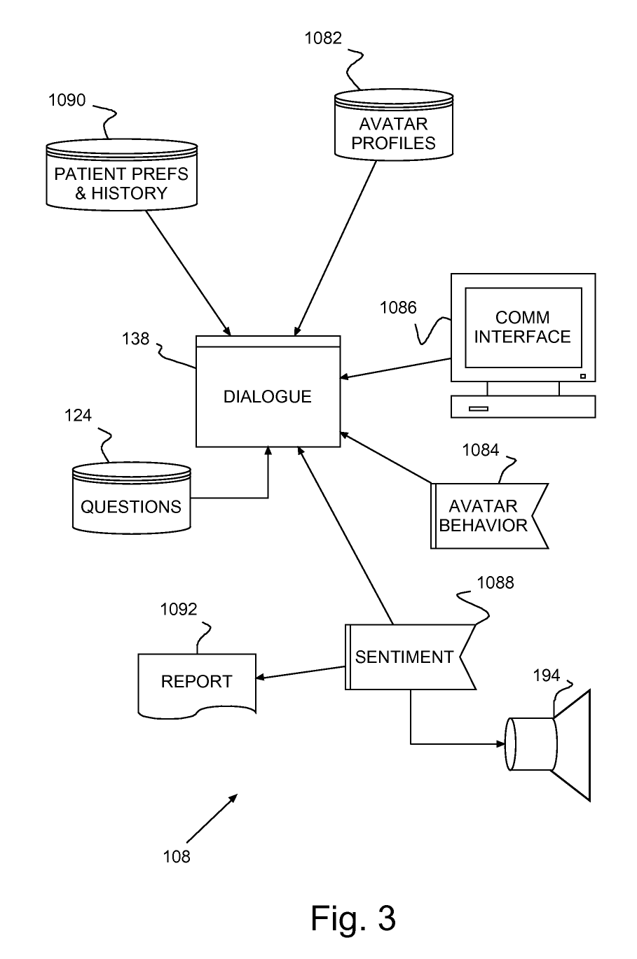

FIG. 3 shows an example of a system 108 for generating surveys/questionnaires 124 and presenting those surveys/questionnaires 124 to users through UCAs 110, 112 according to a preferred embodiment of the present invention with reference to FIG. 1 and FIG. 2. The ordering company 110 sends a survey questionnaire 124 to system dialog module 138, e.g., logging in to add questions 132. The system dialog module 138 accesses an avatar profile database 1082 and chooses one or more VCAs 114, 116, 118, 120 according community group questioned and appropriate virtual incentives. An avatar behavior interpreter 1084 sends the selected avatar(s) 114, 116, 118, 120 to browse for UCAs 110, 112 belonging to the targeted community group and, based on the avatar behavior, identifies appropriate group members. Since the questions are targeted to identified group members, frequently, the same questions are not presented to all UCAs 110, 112. Thus, disinterested or otherwise untargeted UCAs 110, 112 are not bothered by otherwise irrelevant questions. Upon establishing contact the selected avatar(s) 114, 116, 118, 120 communicate through communication interface 1086 with identified UCAs 110, 112 to explain incentives and conduct the survey.

As the selected system avatar(s) 114, 116, 118, 120 communicate through communication interface 1086 with identified UCAs 110, 112, a sentiment interpreter 1088 may monitor UCA answers, e.g., on general mood to determine UCA sentiment. Where the user is a patient, for example, the sentiment interpreter 1088 may monitor possible pain or discomfort indicators. Optionally, the system dialog module 138 may also maintain a patient database 1090 of patients' history and preferences. Preferably, the patient database 1090 also identifies avatar schedules and profiles, matched to visits. Dialog results (e.g., 142 in FIG. 2) may be provided the form of report 1092 and/or alarm 1094.

Advantageously, the preferred VAPS 108 facilitates creating online surveys and polling users through virtual networks without detracting from the users' online experiences. Because the users' online experiences are not degraded, companies and organizations may find it unnecessary to offer incentives to encourage users to complete online surveys, thus saving money for these organizations. Further, pollsters and testing organizations have access to secure virtual profile(s) in a virtual world populated by residents that are potential customers. Pollsters can enter the virtual world, scan user profiles for the UCAs of people that match criteria of interest, teleport themselves (VCAs or UCAs) to online matching people and unobtrusively question the UCAs of those matching people. Preferably, questioning avatars is based on user profile preferences or optimization based on user classification.

Moreover, questioning patients (or elderly or their avatars) on different subjects may be conducted over virtual networks, with the responses/answers providing a basis for making initial estimates of the patients' mood or state. Thus, the VCAs can detect and monitor minor patient discomforts, for example, even those where the person does not think the discomfort is worth it to go to the doctor. Thus, a preferred system facilitates creating surveys and polling users through virtual networks without detracting from individual user's online experience and that allows companies and organizations to save money by not having to offer incentives for users to complete surveys.

While the invention has been described in terms of preferred embodiments, those skilled in the art will recognize that the invention can be practiced with modification within the spirit and scope of the appended claims. It is intended that all such variations and modifications fall within the scope of the appended claims.

What is claimed is:

1. A system for collecting information from users comprising:
means for receiving questions from system clients for presentation to system users;
means for presenting a virtual world to said system users;
means for logging into said virtual world by one or more said system users;
means for creating and maintaining an avatar in said virtual world for each said one or more said system users;
means for creating and maintaining system avatars in said virtual world, said system avatars being distributed throughout said virtual world; and
means for presenting questions from said system avatars to user avatars.

2. A system as in claim 1, further comprising:
means for maintaining a user avatar profile database;
means for scanning user avatar profiles for user avatars matching identified criteria of interest; and
means for teleporting avatars to online matching user avatars, teleporting avatars unobtrusively questioning matching user avatars.

3. A system as in claim 2, wherein said means for scanning scans responsive to selected users logging in and teleports the respective user avatar for the selected user to an online matching user avatar location in the virtual world.

4. A system as in claim 1, wherein said means for presenting questions comprises means for collecting responses and processing collected responses.

5. A system as in claim 4, further comprising means for interpreting user avatar behavior selectively identifying user avatars for questioning based on said user avatar behavior.

6. A system as in claim 5, wherein said means for presenting questions engages system avatars in conversation with user avatars, questions being presented in said conversation and said means for interpreting interprets user mood from sentiment in said collected responses.

7. A system as in claim 1, further comprising a user history and presence database, said system avatars identifying user avatars for presenting questions responsive to user history and presence.

8. A polling system comprising:
questionnaire storage storing questions received from polling system clients for presentation to system users;
avatar storage storing avatar profiles for each of said system users;
a system avatar unit creating, maintaining and controlling a plurality of system avatars;
a dialogue module managing dialogs between said plurality of system avatars and user avatars in a virtual world, said virtual world including a user avatar for each active system user, said system avatars being distributed throughout said virtual world; and
a report generator generating reports responsive to user responses from user avatars to said system avatars.

9. A polling system as in claim 8, further comprising:
a profile scanner selectively scanning user avatar profiles for the user avatars of users matching identified criteria of interest, wherein said means for scanning scans responsive to selected users logging in; and
a virtual teleporter teleporting avatars for each logged in selected user to online matching user avatars, the teleported user avatar unobtrusively questioning respective identified matching user avatars at the user avatar location in the virtual world.

10. A polling system as in claim 8, wherein said dialogue module collects said responses and processes said collected responses.

11. A polling system as in claim 10, further comprising a user avatar behavior interpreter selecting user avatars for questioning based on said user avatar behavior.

12. A polling system as in claim 11, further comprising a user avatar sentiment interpreter interpreting user mood from sentiment in said collected responses.

13. A polling system for polling medical patients as in claim 10, further comprising a patient history and presence database, said system avatars identifying user avatars for presenting questions responsive to patient history and presence.

14. A polling system as in claim 8, wherein said dialogue module selectively engages system avatars in conversation with user avatars, questions being presented in said conversation and said report generator selectively generates an alarm.

15. A method of on-line polling and conducting surveys comprising:
receiving questions from system clients;
distributing a plurality of system avatars throughout a virtual world;
allowing entry by one or more user avatars into said virtual world, said one or more user avatars being under control of respective system users;
posing a subset of said questions by a respective system avatar to said one or more user avatars upon encountering said respective system avatar; and
collecting each user avatar response from to each of said questions to each said respective system avatar and processing collected responses.

16. A method as in claim 15, further comprising:
maintaining a user avatar profile database of user avatars for logged in and previously logged in users;
selectively scanning user avatar profiles for user avatars matching identified criteria of interest; and
teleporting avatars to online matching user avatars, teleported avatars unobtrusively questioning matching user avatars.

17. A method as in claim 16, wherein said means for scanning scans responsive to selected users logging in and teleports the respective user avatar for the selected user to an online matching user avatar location in the virtual world.

18. A method as in claim 15, wherein one or more of said questions is a multipart question and posing a subset comprises posing all parts of the multipart question.

19. A method as in claim 18, further comprising interpreting user avatar behavior and selectively identifying user avatars for questioning based on interpreted said user avatar behavior.

20. A method as in claim 19, wherein interpreting interprets user mood from sentiment in said collected responses.

21. A method as in claim 15, wherein posing a subset comprises engaging respective user avatars in conversation, said subset being included in said conversation, said method further comprising maintaining a patient history and presence database, said system avatars identifying user avatars for posing selected questions responsive to patient history and presence.

22. A computer program product for conducting on-line polls and surveys, said computer program product comprising a computer usable medium having computer readable program code stored thereon, said computer readable program code comprising:
computer readable program code means for storing system client questions;
computer readable program code means for storing profiles of user avatars;
computer readable program code means for distributing a plurality of system avatars throughout a virtual world;
computer readable program code means for allowing entry by one or more said user avatars into said virtual world, said one or more user avatars being under control of respective system users;
computer readable program code means for selecting and posing a subset of said system client questions by a respective system avatar to said one or more user avatars upon encountering said respective system avatar; and
computer readable program code means for collecting each user avatar response from to each of said questions to each said respective system avatar and processing collected responses.

23. A computer program product for conducting on-line polls and surveys as in claim 22, further comprising computer readable program code means for maintaining a user avatar profile database of user avatars for previously logged in users.

24. A computer program product for conducting on-line polls and surveys as in claim 22, wherein the computer readable program code means for selecting and posing engages system avatars in conversation with user avatars, said subset being posed in said conversation and, the computer program product further comprising computer readable program code means for interpreting user avatar behavior and selectively identifying user avatars for questioning based on interpreted said user avatar behavior.

25. A computer program product for conducting on-line polls and surveys as in claim 22, further comprising:
computer readable program code means for scanning user avatar profiles for the user avatars of users matching identified criteria of interest;
computer readable program code means for teleporting avatars to online matching user avatars and unobtrusively questioning the matching user avatars.
